(19) United States
(12) Patent Application Publication
(10) Pub. No.: US 2026/0020090 A1
(43) Pub. Date: Jan. 15, 2026

(54) MULTI-BLUETOOTH SYSTEM CAPABLE OF ENHANCING USER EXPERIENCE

(71) Applicant: MEDIATEK INC., Hsinchu City (TW)

(72) Inventors: Hsien-Hsin Wu, Hsinchu City (TW); You-Jheng Wang, Hsinchu City (TW)

(73) Assignee: MEDIATEK INC., Hsinchu City (TW)

(21) Appl. No.: 19/254,006

(22) Filed: Jun. 30, 2025

Related U.S. Application Data
(60) Provisional application No. 63/669,744, filed on Jul. 11, 2024.

(51) Int. Cl. H04W 76/14; H04B 17/318; H04W 56/00

(52) U.S. Cl. CPC H04W 76/14; H04B 17/318; H04W 56/0015

(57) ABSTRACT

A method of an electronic system device includes; providing an integrated Bluetooth device including a first Bluetooth device having a first unique device address and a first configuration information and at least one second Bluetooth device having at least one second unique device address and at least one second configuration information; providing a central control unit to configure and manage device addresses and configuration information of Bluetooth communications; and, using the central control unit to control the first Bluetooth device and the at least one second Bluetooth device to use a same device address to pair with and connect with a peer device, to make the peer device directly connect with the at least one second Bluetooth device without pairing with the at least one second Bluetooth device after the peer device has been paired with the first Bluetooth device.

### CROSS REFERENCE TO RELATED APPLICATIONS

This application claims the benefit of U.S. Provisional Application No. 63/669,744, filed on Jul. 11, 2024. The content of the application is incorporated herein by reference.

### BACKGROUND

Generally speaking, multiple Bluetooth controllers in a conventional Bluetooth system respectively use different and unique device addresses as identifications to pair with one or more electronic devices such as peer electronic device(s). Before communicating with a conventional Bluetooth controller to transfer data, the peer electronic device needs to successfully pair with the conventional Bluetooth controller.

### SUMMARY

Therefore one of the objectives of the invention is to provide an electronic system device and corresponding method, to solve the above-mentioned problems.

According to embodiments of the invention, an electronic system device is disclosed. The electronic system device comprises an integrated Bluetooth device and a central control unit. The integrated Bluetooth device comprises a first Bluetooth device and at least one second Bluetooth device. The first Bluetooth device has a first unique device address and a first configuration information. The at least one second Bluetooth device has at least one second unique device address and at least one second configuration information. The central control unit, coupled to the first Bluetooth device and the at least one second Bluetooth device, is used for configuring and managing device addresses and configuration information of Bluetooth communications. The central control unit is used to control the first Bluetooth device and the at least one second Bluetooth device to use a same device address to pair with and connect with a peer device, and the peer device can directly connect with the at least one second Bluetooth device without pairing with the at least one second Bluetooth device after the peer device has been paired with the first Bluetooth device.

According to embodiments of the invention, a method of an electronic system device is disclosed. The method comprises; providing an integrated Bluetooth device comprising a first Bluetooth device having a first unique device address and a first configuration information and at least one second Bluetooth device having at least one second unique device address and at least one second configuration information; providing a central control unit to configure and manage device addresses and configuration information of Bluetooth communications; and, using the central control unit to control the first Bluetooth device and the at least one second Bluetooth device to use a same device address to pair with and connect with a peer device, to make the peer device directly connect with the at least one second Bluetooth device without pairing with the at least one second Bluetooth device after the peer device has been paired with the first Bluetooth device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic system device 100 according to an embodiment of the invention.

FIG. 2 is a diagram of an application scenario of an example of the electronic system device and corresponding operation method as shown in FIG. 1 according to an embodiment of the invention.

FIG. 3 is a flowchart diagram of an example of the operations of electronic system device as shown in FIG. 1 according to an embodiment of the invention.

### DETAILED DESCRIPTION

The invention aims at providing an electronic device and corresponding method capable of enhancing the user's experience by multi-Bluetooth unified pairing when using multiple Bluetooth devices through device address synchronization and pairing information synchronization. The corresponding method can allow peer Bluetooth device(s) to pair with one Bluetooth device for only one time and then connect with more different Bluetooth devices without needing to pair the more different Bluetooth devices again. The method can be applied for different application scenarios such as an interior/cabin space of a vehicle/car device or a specific/personal workspace (or house). It is merely needed for a peer device to pair with only one Bluetooth device, and more or all Bluetooth devices at the same place can be paired with such peer device and thus the peer device does not need to perform a pairing procedure with the other Bluetooth devices at the same place.

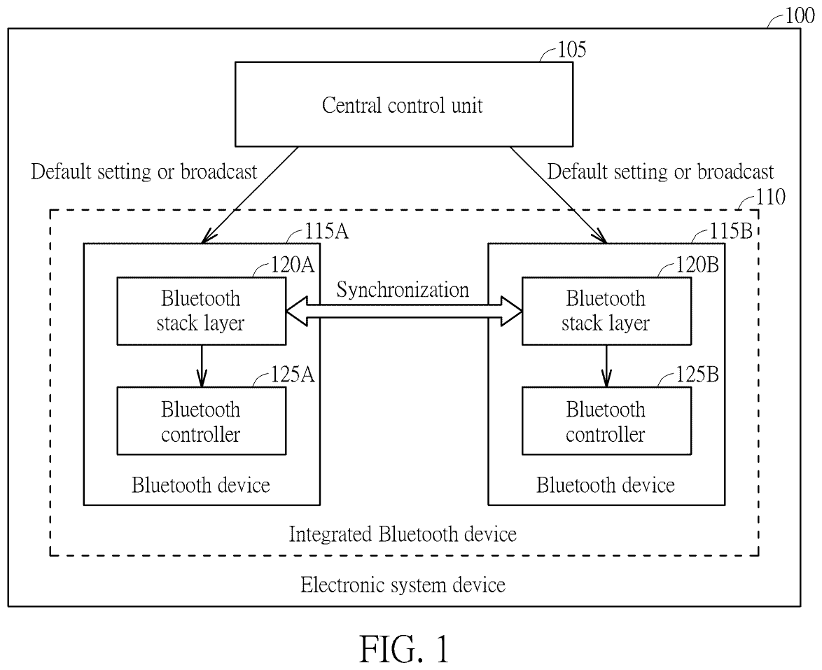

FIG. 1 is a diagram of an electronic system device 100 according to an embodiment of the invention. The electronic system device 100 comprises a central control unit 105 such as CPU (central processing unit) and an integrated Bluetooth device 110.

The integrated Bluetooth device 110 comprises a first Bluetooth device 115A and at least one second Bluetooth device 115B. The first Bluetooth device 115A comprises a first Bluetooth stack layer 120A and a first Bluetooth controller 125A. The at least one second Bluetooth device 115B comprises at least one second Bluetooth stack layer 120B and at least one second Bluetooth controller 125B.

In a default setting, the first Bluetooth controller 125A has a first unique device address and first configuration information. The at least one second Bluetooth device 115B correspondingly has at least one second unique device address and at least one second configuration information different from the first configuration information.

The central control unit 105 is coupled to the first Bluetooth device 115A and the at least one second Bluetooth device 115B, and is used for configuring and managing device addresses and configuration information of Bluetooth communications.

The central control unit 105 is used to control the first Bluetooth device 115A and the at least one second Bluetooth device 115B to use a same device address to pair with and connect with a peer device such as a peer Bluetooth device which is not comprised within the electronic system device 100. That is, the same device address of Bluetooth communication is shared and together used by the first Bluetooth device 115A and the at least one second Bluetooth device 115B, e.g. multiple or all Bluetooth devices comprised by the integrated Bluetooth device 110. After the peer device, which is never paired with the second Bluetooth device(s) 115B, has been paired with the first Bluetooth device 115A, the peer device can directly connect with the second Bluetooth device(s) 115B without pairing with the second Bluetooth device(s) 115B even though the peer device has never been paired with the at least one second Bluetooth device 115B. The same device address is used by the multiple or all Bluetooth devices comprised by the integrated Bluetooth device 110, and the peer device may regard the integrated Bluetooth device 110 as a single one Bluetooth device.

In one embodiment, the same device address may be the first unique device address if the peer device is paired with the first Bluetooth device 115A for the first. For example, after the peer device has been paired with the first Bluetooth device 115A, the first Bluetooth device 115A is used to synchronize with the second Bluetooth device(s) 115B by forcing the device address(es) employed by the second Bluetooth device(s) 115B be changed from the second unique device address(es) into the first unique device address, so as to make the peer device directly connect with and communicate with the second Bluetooth device(s) 115B based on the first unique device address to transfer data (e.g. secured data), without pairing with the second Bluetooth device(s) 115B based on the second unique device address(s).

In addition, in one embodiment, in a default setting, the central control unit 105 is used to set the first configuration information be different from the at least one second configuration information. That is, the initial configuration (or the currently used configuration) of the first Bluetooth device 115A may be different from the configuration of the second Bluetooth device(s) 115B; however, this is not intended to be a limitation. After the peer device is (or has been) paired with the first Bluetooth device 115A, the first Bluetooth device 115A is also used to synchronize with the second Bluetooth device(s) 115B by further forcing configuration information employed by the second Bluetooth device(s) 115B be changed from the second configuration information into the first configuration information.

In practice, for the synchronization of device address and/or configuration information, if the first Bluetooth device 115A needs to synchronize the first configuration information with the configuration information employed by the second Bluetooth device(s) 115B, then the first Bluetooth stack layer 120A after the first Bluetooth device 115A is paired with the peer device is arranged to send a synchronization request to the central control unit 105 and then the central control unit 105 is used to force the second Bluetooth stack layer(s) 120B within second Bluetooth device(s) 115B to modify the device address and/or configuration information of second Bluetooth controller(s) 125B as the first unique device address and the first configuration information. That is, when one Bluetooth controller is paired with the peer device, the central control unit 105 controls the other different Bluetooth stack layers to modify the different corresponding Bluetooth controllers' device addresses and/or configuration information as the device address and/or configuration information employed by such Bluetooth controller which has been successfully paired with the peer device. By doing so, all the Bluetooth stack layers within the integrated Bluetooth device 110 can share and together use the same device address and/or configuration information (or pairing information). In addition, for example, the employed configuration information may comprise at least one of a device list, inquiry information, page information, and link key information. This is not intended to be a limitation of the invention.

Further, in one embodiment, when the peer device, which has been paired with and is disconnected from the first Bluetooth device 115A, tries to connect/reconnect to the integrated Bluetooth device 110, the central control unit 105 is arranged to broadcast a pairing request associated with the same device address to the first Bluetooth device 115A and the second Bluetooth device(s) 115B; that is, the central control unit 105 broadcasts a pairing request corresponding to the same device address to all the Bluetooth devices in the integrated Bluetooth device 110. Then, one Bluetooth device such as a specific Bluetooth device of the second Bluetooth device(s) 115B is selected by the central control unit 105 to connect and communicate with the peer device to transfer data (e.g. secured data), and the first Bluetooth device 115A is not selected to connect with the peer device. In one embodiment, regardless of the specific Bluetooth device is previously paired with the peer device, any Bluetooth device with the same device address can be connected by the peer device.

In one embodiment, the specific Bluetooth device selected from the second Bluetooth devices 115B can be a Bluetooth device having a better signal quality than the other Bluetooth devices. For example, a signal power strength of a signal between the peer device and the specific Bluetooth device is higher than a signal power strength of a signal between the peer device and the first Bluetooth device 115A (or the other different Bluetooth devices 115B).

In one embodiment, a signal distance of a signal from the peer device to the specific Bluetooth device is shorter than a signal distance of a signal from the peer device to the first Bluetooth device 115A (or the other different Bluetooth devices 115B).

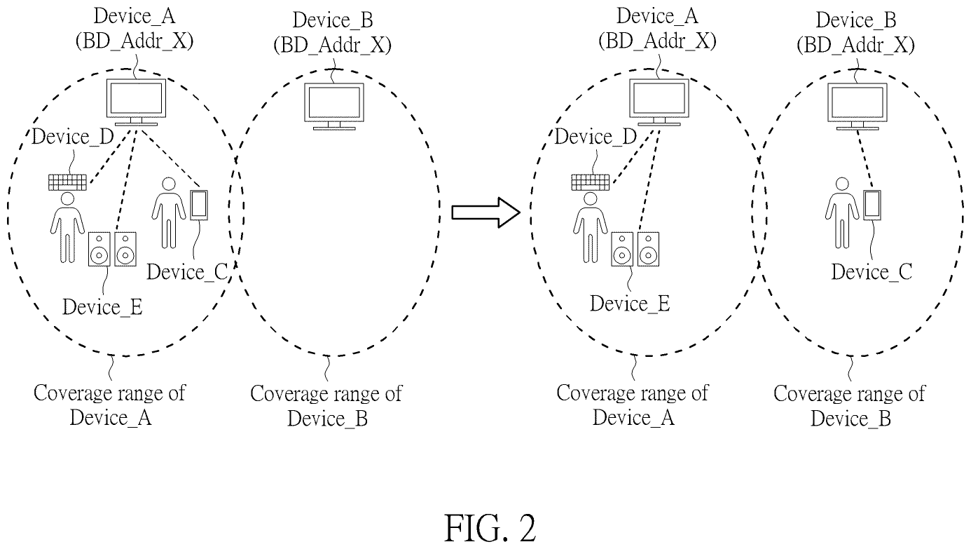

FIG. 2 is a diagram of an application scenario of an example of the electronic system device 100 and corresponding operation method as shown in FIG. 1 according to an embodiment of the invention. As shown in FIG. 2, for example (but not limited), in the left of FIG. 2, the Bluetooth device Device_A can be the first Bluetooth device 115A while the Bluetooth device Device_B can be a second Bluetooth device 115B as shown in FIG. 1, and Bluetooth devices Device_A and Device_B share and use the same device address BD_Addr_X such as 6 bytes (i.e. 48 bits) formed by the same address value ‘11:22:33:44:55:66’ (but not limited). In this situation, the coverage ranges of the Bluetooth devices Device_A and Device_B are almost different and there is only a smaller overlap portion. A first user's keyboard device Device_D and earphone device Device_E are in the coverage range of Bluetooth device Device_A and paired with and connected to the Bluetooth device Device_A through the address value ‘11:22:33:44:55:66’, and a second user's smart phone device Device_C is also in the coverage range of Bluetooth device Device_A and also paired with and connected to the Bluetooth device Device_A through the same address value ‘11:22:33:44:55:66’. Then, the second user may move from the coverage range of Bluetooth device Device_A into the coverage range of Bluetooth device Device_B, as shown in the right of FIG. 2. In this situation, the second user's smart phone device Device_C is now in the coverage range of Bluetooth device Device_B and can directly connect to and communicate with the Bluetooth device Device_B through the same address value ‘11:22:33:44:55:66’ to transfer data (e.g. secured data) without performing a pairing procedure with the Bluetooth device Device_B even though the smart phone device Device_C is never paired with the Bluetooth device Device_B. Thus, the second user's experience can be significantly improved.

Further, for example, the electronic system device 100 is a car system device (but not limited), and the central control unit 105 and integrated Bluetooth device 110 can be installed and configured in a car device component of the car system device or can be respectively installed and configured in different car device components of car system device. The car device component for example is an in-vehicle infotainment information head unit (but not limited). The Bluetooth devices in the integrated Bluetooth device 110 may be disposed at different positions in the car system device. By doing so, when a peer device has been paired with one Bluetooth device installed within the car system device, the peer device can directly connect to and communicate with the other different Bluetooth devices installed within the car system device to transfer data (e.g. secured data, audio data, or non-audio data) without performing the pairing procedure with the other different Bluetooth devices one by one. The performance can be significantly improved.

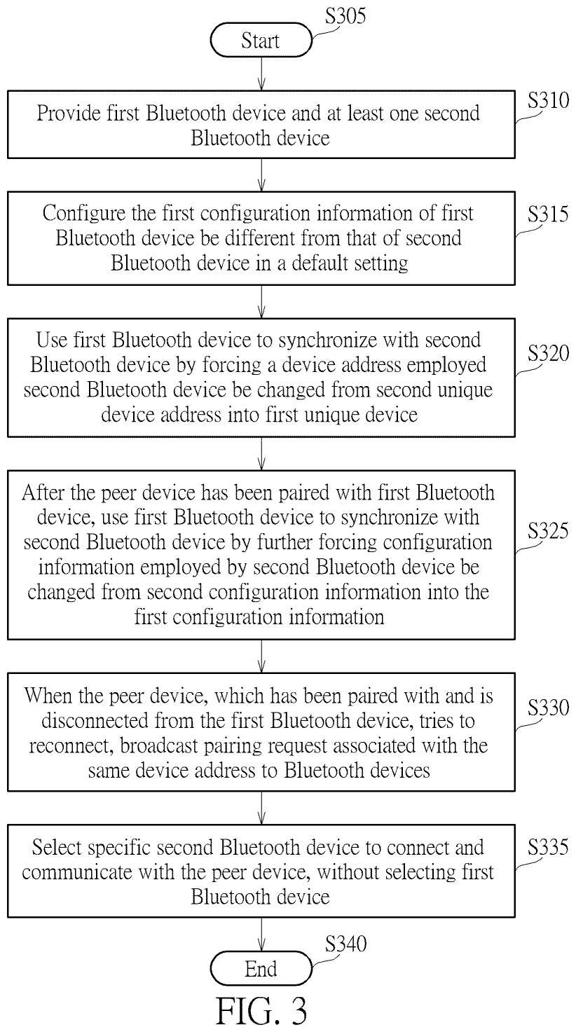

To make the reader more clearly understand the spirits of the invention, FIG. 3 is provided. FIG. 3 is a flowchart diagram of an example of the operations of electronic system device 100 as shown in FIG. 1 according to an embodiment of the invention. The descriptions of steps are listed in the following:
Step S305: Start;
Step S310: providing a first Bluetooth device having a first unique device address and a first configuration information and at least one second Bluetooth device having at least one second unique device address and at least one second configuration information;
Step S315: configuring the first configuration information be different from the at least one second configuration information in a default setting;
Step S320: after a peer device has been paired with the first Bluetooth device, using the first Bluetooth device to synchronize with the at least one second Bluetooth device by forcing a device address employed by the at least one second Bluetooth device be changed from the at least one second unique device address into the first unique device address so as to make the peer device directly connect with the at least one second Bluetooth device based on the first unique device address, without pairing with the at least one second Bluetooth device based on the at least one second unique device address;
Step S325: after the peer device has been paired with the first Bluetooth device, using the first Bluetooth device to synchronize with the at least one second Bluetooth device by further forcing a configuration information employed by the at least one second Bluetooth device be changed from the at least one second configuration information into the first configuration information;
Step S330: when the peer device, which has been paired with and is disconnected from the first Bluetooth device, tries to reconnect, broadcasting a pairing request associated with the same device address to the first Bluetooth device and the at least one second Bluetooth device;
Step S335: selecting a specific Bluetooth device of the at least one second Bluetooth device to connect and communicate with the peer device, without selecting the first Bluetooth device to connect with the peer device; and
Step S340: End.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system device, comprising:
an integrated Bluetooth device, comprising:
a first Bluetooth device, having a first unique device address and a first configuration information; and
at least one second Bluetooth device, having at least one second unique device address and at least one second configuration information; and
a central control unit, coupled to the first Bluetooth device and the at least one second Bluetooth device, for configuring and managing device addresses and configuration information of Bluetooth communications;
wherein the central control unit is used to control the first Bluetooth device and the at least one second Bluetooth device to use a same device address, and a peer device directly connects with the at least one second Bluetooth device without pairing with the at least one second Bluetooth device after the peer device has been paired with the first Bluetooth device.

2. The electronic system device of claim 1, wherein in a default setting the central control unit is used to set the first configuration information be different from the at least one second configuration information; and, after the peer device has been paired with the first Bluetooth device, the first Bluetooth device is used to synchronize with the at least one second Bluetooth device by forcing a device address employed by the at least one second Bluetooth device be changed from the at least one second unique device address into the first unique device address so as to make the peer device directly connect with the at least one second Bluetooth device based on the first unique device address, without pairing with the at least one second Bluetooth device based on the at least one second unique device address.

3. The electronic system device of claim 2, wherein after the peer device has been paired with the first Bluetooth device, the first Bluetooth device is used to synchronize with the at least one second Bluetooth device by further forcing a configuration information employed by the at least one second Bluetooth device be changed from the at least one second configuration information into the first configuration information.

4. The electronic system device of claim 3, wherein the first Bluetooth device comprises a first Bluetooth stack layer and a first Bluetooth controller, and the at least one second Bluetooth device comprises at least one second Bluetooth stack layer and at least one second Bluetooth controller; the first Bluetooth stack layer is arranged to synchronize the first configuration information with the configuration information employed by the at least one second Bluetooth stack layer.

5. The electronic system device of claim 3, wherein the employed configuration information comprises at least one of a device list, inquiry information, page information, and link key information.

6. The electronic system device of claim 1, wherein when the peer device, which has been paired with and is disconnected from the first Bluetooth device, tries to reconnect the integrated Bluetooth device, the central control unit is arranged to broadcast a pairing request associated with the same device address to the first Bluetooth device and the at least one second Bluetooth device.

7. The electronic system device of claim 6, wherein a specific Bluetooth device of the at least one second Bluetooth device is selected by the central control unit to connect and communicate with the peer device, and the first Bluetooth device is not selected to connect with the peer device.

8. The electronic system device of claim 7, wherein a signal power strength of a signal between the peer device and the specific Bluetooth device is higher than a signal power strength of a signal between the peer device and the first Bluetooth device.

9. The electronic system device of claim 7, wherein a signal distance of a signal from the peer device to the specific Bluetooth device is shorter than a signal distance of a signal from the peer device to the first Bluetooth device.

10. A method of an electronic system device, comprising:
providing an integrated Bluetooth device, comprising:
a first Bluetooth device, having a first unique device address and a first configuration information; and
at least one second Bluetooth device, having at least one second unique device address and at least one second configuration information;
providing a central control unit to configure and manage device addresses and configuration information of Bluetooth communications; and
using the central control unit to control the first Bluetooth device and the at least one second Bluetooth device to use a same device address, to make a peer device directly connect with the at least one second Bluetooth device without pairing with the at least one second Bluetooth device after the peer device has been paired with the first Bluetooth device.

11. The method of claim 10, further comprising;
using the central control unit in a default setting to set the first configuration information be different from the at least one second configuration information; and
after the peer device has been paired with the first Bluetooth device, using the first Bluetooth device to synchronize with the at least one second Bluetooth device by forcing a device address employed by the at least one second Bluetooth device be changed from the at least one second unique device address into the first unique device address so as to make the peer device directly connect with the at least one second Bluetooth device based on the first unique device address, without pairing with the at least one second Bluetooth device based on the at least one second unique device address.

12. The method of claim 11, further comprising;
after the peer device has been paired with the first Bluetooth device, using the first Bluetooth device to synchronize with the at least one second Bluetooth device by further forcing a configuration information employed by the at least one second Bluetooth device be changed from the at least one second configuration information into the first configuration information.

13. The method of claim 12, wherein the first Bluetooth device comprises a first Bluetooth stack layer and a first Bluetooth controller, and the at least one second Bluetooth device comprises at least one second Bluetooth stack layer and at least one second Bluetooth controller; the first Bluetooth stack layer is arranged to synchronize the first configuration information with the configuration information employed by the at least one second Bluetooth stack layer.

14. The method of claim 12, wherein the employed configuration information comprises at least one of a device list, inquiry information, page information, and link key information.

15. The method of claim 10, further comprising;
when the peer device, which has been paired with and is disconnected from the first Bluetooth device, tries to reconnect the integrated Bluetooth device, using the central control unit to broadcast a pairing request associated with the same device address to the first Bluetooth device and the at least one second Bluetooth device.

16. The method of claim 15, further comprising;
using the central control unit to select a specific Bluetooth device of the at least one second Bluetooth device to connect and communicate with the peer device, without selecting the first Bluetooth device to connect with the peer device.

17. The method of claim 16, wherein a signal power strength of a signal between the peer device and the specific Bluetooth device is higher than a signal power strength of a signal between the peer device and the first Bluetooth device.

18. The method of claim 16, wherein a signal distance of a signal from the peer device to the specific Bluetooth device is shorter than a signal distance of a signal from the peer device to the first Bluetooth device.
